(19) United States
(12) Patent Application Publication
(10) Pub. No.: US 2019/0091914 A1
(43) Pub. Date: Mar. 28, 2019

(54) Rubber Preforming Apparatus

(71) Applicant: Multiple Corporation, Nan Tou City (TW)

(72) Inventors: Liang-Pang Yang, Nan Tou City (TW); Hsueh-Cheng Liao, Nan Tou City (TW)

(21) Appl. No.: 15/712,233

(22) Filed: Sep. 22, 2017

(51) Int. Cl. B29C 47/36

(52) U.S. Cl. CPC B29C 47/364; B29K 2021/00

(57) ABSTRACT

A rubber preforming apparatus includes a direct drive motor unit slidably disposed on a base unit. The direct drive motor unit includes a drive motor and a deceleration mechanism. The deceleration mechanism includes an input shaft coupling and an output shaft coupling axially aligned with and co-rotatably connected to the input shaft coupling. A drive spindle of the drive motor is inserted into and rotating together with the input shaft coupling. An extruder casing is disposed adjacent to the output shaft coupling and has a squeezing space. An extruder screw is disposed in the squeezing space, and includes a screw shaft with one end coaxially inserted into and rotating together with the output shaft coupling.

### FIELD

The disclosure relates to a preforming apparatus, and more particularly to a rubber preforming apparatus.

### BACKGROUND

Referring to FIGS. 1 and 2, an existing rubber preforming apparatus includes a drive motor 11, a deceleration unit 12 driven by and rotating together with the drive motor 11, a shaft coupling 13 connected to the deceleration unit 12, an extruder unit 14 connected to the shaft coupling 13, a gear metering pump 15 connected to the extruder unit 14, a die 16 connected to the gear metering pump 15, and a cutting-and-collecting unit 17 connected to the die 16. The drive motor 11 has a drive spindle 111 rotating about a first axis (S1). The deceleration unit 12 includes a decelerating shaft 121 extending into the shaft coupling 13 and rotating about a second axis (S2) parallel with the first axis (S1). The decelerating shaft 121 is driven by and rotates together with the drive spindle 111. The extruder unit 14 includes an extruder screw 141 extending into the shaft coupling 13 oppositely of the deceleration shaft 121. The gear metering pump 15 includes an inlet port 152 disposed adjacent to the extruder screw 141, an exit port 153 disposed adjacent to the die 16, and two gears 151 disposed between the inlet and exit ports 152, 153.

During operation of the existing rubber preforming apparatus, the drive motor 11 drives rotation of the drive spindle 111 together with the deceleration shaft 121 to rotate the extruder screw 141 through the shaft coupling 13. The rotation of the extruder screw 141 extrudes a rubber material (not shown) to pass the inlet port 152, the gears 151 and the exit port 153. The die 16 forms the rubber material extruded from the extruder screw 141 into a rubber rod (not shown). The cutting-and-collecting unit 17 cuts the rubber rod into a plurality of finished rubber products (not shown) for subsequent use.

Due to the structural arrangement of the existing rubber preforming apparatus in which the deceleration unit 12, the shaft coupling 13 and the extruder unit 14 are tightly connected to each other, when the extruder unit 14 needs to be maintained or repaired, the deceleration unit 12 and the shaft coupling 13 have to be detached consecutively. Because the shaft coupling 13 is fixed to the deceleration unit 12 and the extruder screw 141, inconveniences may be caused in assembly or disassembly. Further, because assembly of the shaft coupling 13 may results in prolongation of an entire length of the existing rubber preforming apparatus, the existing rubber preforming apparatus may occupy relatively large space. Moreover, when cleaning is required after completion of processing the rubber material, the gear metering pump 15 having a relatively large volume must be first detached to subsequently clean the die 16 and the cutting-and-collecting unit 17. Therefore, the cleaning process is very inconvenient.

In addition, the inlet port 152 has a short distance between an upstream end 1521 of the inlet port 152 and a meshing point between the two gears 151. When the gears 151 rotate to squeeze the rubber material (not shown) passing through the inlet port 152, a relatively high load pressure can be created at an instant contact between the rubber material and each tooth of the gears 151, resulting in unstable quality of subsequently produced rubber rods (not shown).

### SUMMARY

Therefore, an object of the disclosure is to provide a rubber preforming apparatus that can overcome at least one drawback of the prior art.

According to the disclosure, a rubber preforming apparatus includes a base unit, a direct drive motor unit, an extruder unit and a die.

The direct drive motor unit is slidably disposed on the base unit, and includes a drive motor and a deceleration mechanism. The drive motor includes a drive spindle. The deceleration mechanism includes a casing, an input shaft coupling and an output shaft coupling. The input shaft coupling is rotatably disposed in the casing. The drive spindle is inserted into and rotates together with the input shaft coupling. The output shaft coupling is axially aligned and co-rotatably connected to the input shaft coupling, and has a rotation speed smaller than that of the input shaft coupling.

The extruder unit includes an extruder casing, a heating member to heat the extruder casing, and an extruder screw. The extruder casing is disposed adjacent to the output shaft coupling and has a squeezing space for accommodating a rubber material. The extruder screw is disposed in the squeezing space, and includes a screw shaft with one end removably and coaxially inserted into and rotating together with the output shaft coupling for extruding the rubber material.

The die is connected to the extruder casing oppositely of the output shaft coupling for forming the rubber material extruded from the extruder unit into a rubber rod.

### BRIEF DESCRIPTION OF THE DRAWINGS

Other features and advantages of the disclosure will become apparent in the following detailed description of the embodiment with reference to the accompanying drawings, of which:

FIG. 1 illustrates an existing rubber preforming apparatus;

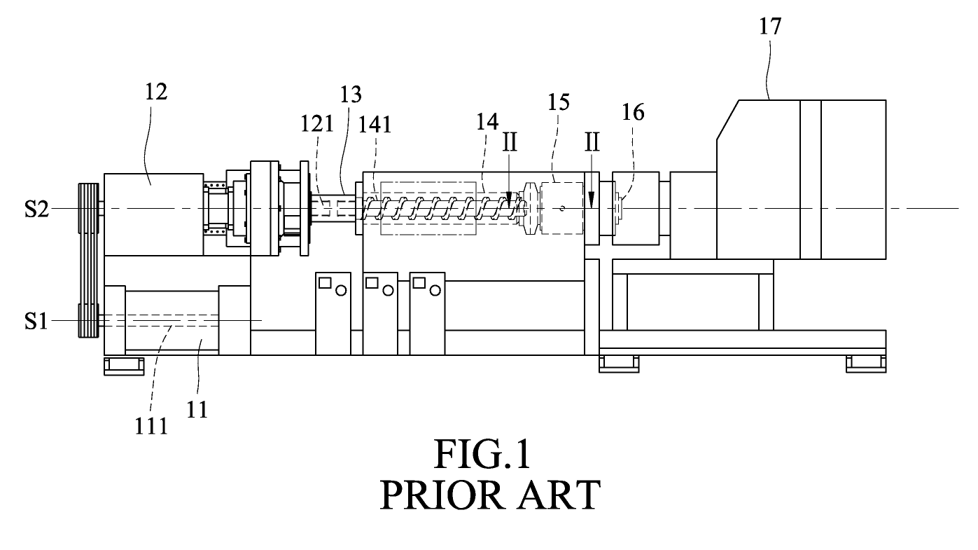

FIG. 2 is a partly sectional view taken along line II-II of FIG. 1;

FIG. 3 is a top view, illustrating a rubber preforming apparatus according to an embodiment of the present disclosure;

FIG. 4 is a side view of the embodiment;

FIG. 5 is a partly sectional view taken along line V-V of FIG. 5;

FIG. 6 is a fragmentary perspective view of the embodiment, illustrating a direct drive motor and a screw shaft of the rubber preforming apparatus;

FIG. 7 is similar to FIG. 4, but illustrating detachment of the direct drive motor from an extruder unit of the rubber preforming apparatus; and

FIG. 8 is similar to FIG. 4, but illustrating the direct drive motor and the extruder unit detached from a gear metering pump of the rubber preforming apparatus.

### DETAILED DESCRIPTION

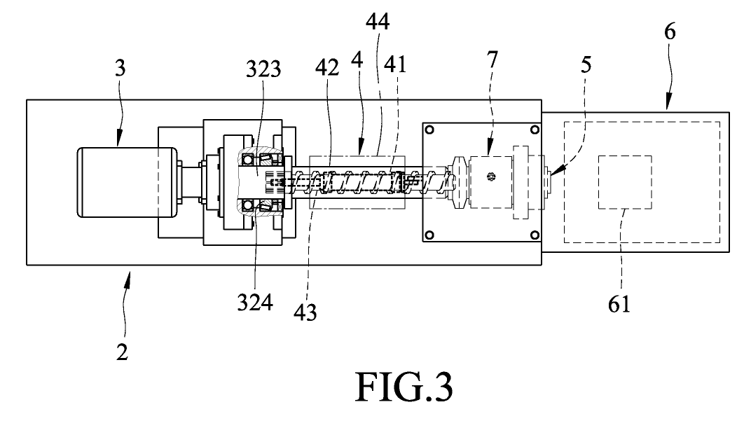

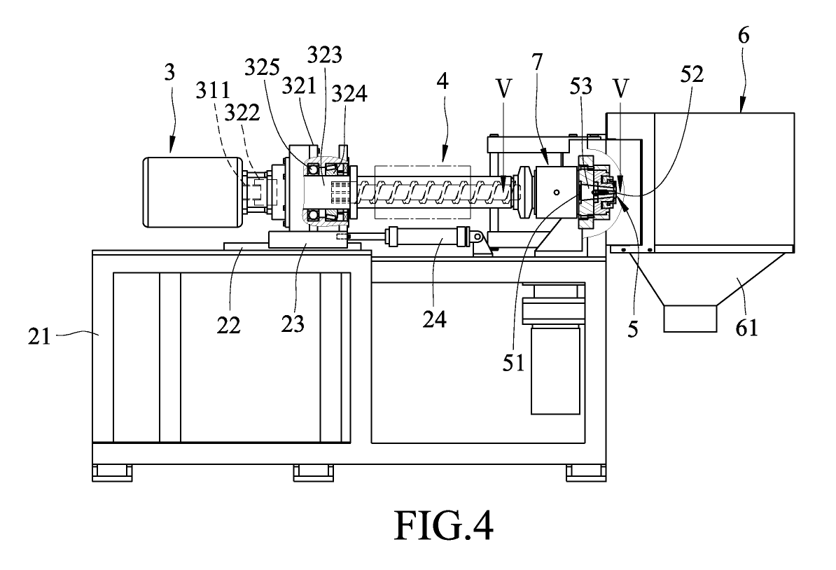

Referring to FIGS. 3 and 4, a rubber preforming apparatus according to an embodiment of the present disclosure includes a base unit 2, a direct drive motor unit 3, an extruder unit 4, a die 5, a cutting-and-collecting unit 6 and a gear metering pump 7.

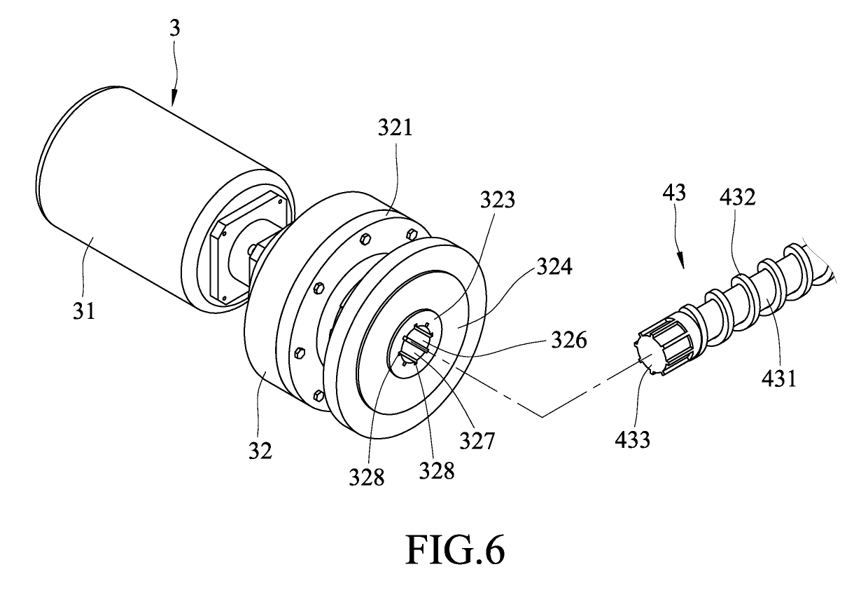

Referring to FIG. 6, in combination with FIGS. 3 and 4, the base unit 2 includes a main body 21, a rail 22 mounted on a top face of the main body 21, a sliding seat 23 slidable along the rail 22, and a pressure cylinder 24 disposed on the main body for driving the sliding seat 23 to slide.

The direct drive motor unit 3 is mounted on the sliding seat 23, and includes a drive motor 31 and a deceleration mechanism 32.

The drive motor 31 includes a drive spindle 311.

The deceleration mechanism 32 includes a casing 321, an input shaft coupling 322, an output shaft coupling 323, a thrust bearing 324 and a supporting bearing 325. The input shaft coupling 322 is rotatably disposed in the casing 321. The drive spindle 311 is inserted into and rotates together with the input shaft coupling 322. The output shaft coupling 323 is axially aligned and co-rotatably connected to the input shaft coupling 322, and has a rotation speed smaller than that of the input shaft coupling 322. The thrust bearing 324 is disposed between the casing 321 and the output shaft coupling 323 proximally to a screw shaft 431 of an extruder screw 43 (details will be described hereinafter) for bearing an axial load induced by the extruder screw 43. The supporting bearing 325 is disposed between the casing 321 and the output shaft coupling 323 at one side of the thrust bearing 324 opposite to the screw shaft 431 for supporting the output shaft coupling 323. In this embodiment, the input and output shaft couplings 322, 323 are connected to a speed change mechanism (not shown).

The output shaft coupling 323 has a coupling hole 326. The coupling hole 326 has a central hole portion 327 and a plurality of angularly spaced apart recesses 328 communicated with and disposed around the central hole portion 327. Each of the recesses 328 is elongated axially.

The extruder unit 4 includes an extruder casing 42, a heating member 44, and the extruder screw 43. The extruder casing 42 is disposed adjacent to the output shaft coupling 323 and has a squeezing space 41 for accommodating a rubber material. The heating member 44 is used to heat the extruder casing 42. The extruder screw 43 is disposed in the squeezing space 41.

The extruder screw 43 includes the screw shaft 431 and a spiral plate 432. The screw shaft 431 has one end 433 removably and coaxially inserted into and rotating together with the output shaft coupling 323 to rotate the spiral plate 432 spirally disposed around the screw shaft 431 for delivering or extruding the rubber material to the die 5 (details will be described hereinafter).

The end 433 of the screw shaft 431 is inserted into the coupling hole 326, and has a cross section conforming to that of the coupling hole 26.

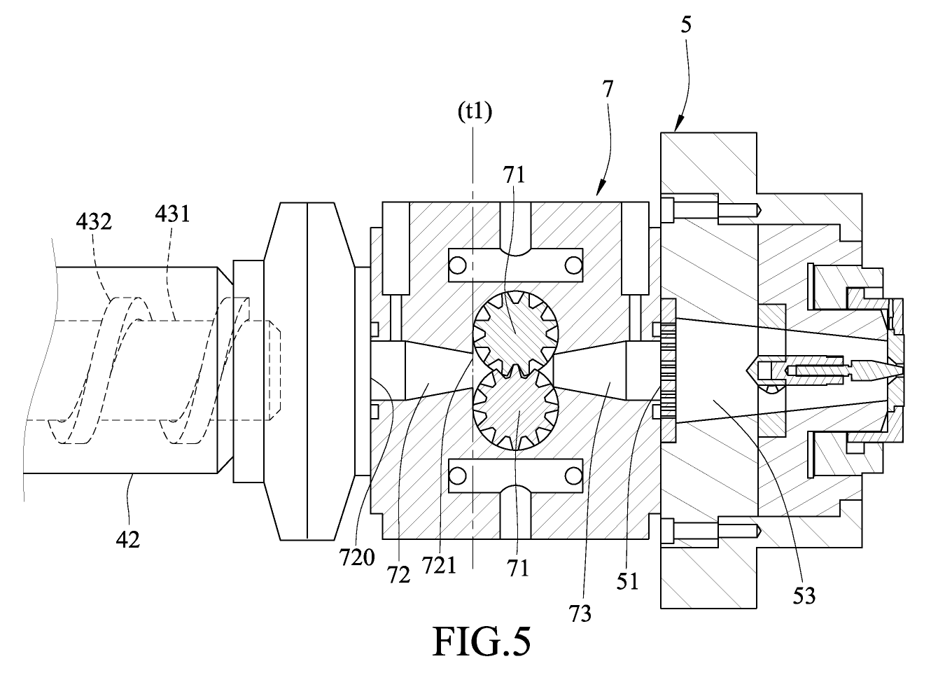

Referring to FIG. 5, in combination with FIGS. 3 and 4, the die 5 is connected to the extruder casing 42 oppositely of the output shaft coupling 323 for forming the rubber material extruded from the extruder unit 4 into a rubber rod (not shown). The die 5 includes a die inlet 51 communicating with the squeezing space 41, a die outlet 52 opposite to the die inlet 51, and a die cavity 53 connecting between the die inlet 51 and the die outlet 52.

The gear metering pump 7 is disposed between the squeezing space 41 of the extruder casing 42 and the die 5. The gear metering pump 7 includes an inlet port 72 communicating with the squeezing space 41, an exit port 73 communicating with the inlet port 72 and the die inlet 51 of the die 5, and two gears 71 disposed between the inlet and exit ports 72, 73. The inlet port 72 has a downstream end 721 that meets and terminates at a common tangent line (t1) tangent to both of the gears 71. The gears 71 are rotatably meshed with each other to squeeze the rubber material from the inlet port 72 to the die inlet 51 of the die 5 through the exit port 73. In this embodiment, the gear metering pump 7 is detachable from the extruder unit 4.

The cutting-and-collecting unit 6 is disposed on the base unit 2 in proximity to the die outlet 52 of the die 5 for cutting and collecting the rubber rod (not shown) formed by the die 5. The cutting-and-collecting unit 6 includes a cutting mechanism (not shown) proximal to the die outlet 52 of the die 5, a hopper 61 and a conveyor (not shown) disposed between the cutting mechanism and the hopper 61.

Referring back to FIGS. 3, 5 and 6, during operation of the rubber preforming apparatus of the disclosure, the rubber material (not shown) is introduced into the squeezing space 41 of the extruder casing 42. The direct drive motor unit 3 drives the extruder screw 43 to rotate the spiral plate 432 for conveying the rubber material to the gear metering pump 7. Simultaneously, the heating member 44 heats the extruder casing 42 such that the rubber material is softened. After the rubber material passes through the inlet port 72 and is extruded out from the gears 71, the rubber material is pushed into the die cavity 53 through the exit port 73 of the gear metering pump 7 and the die inlet 51 of the die 5. The rubber material is extruded in the form of the rubber rod (not shown) with a predetermined shape from the die cavity 53. The rubber rod is cut into a plurality of finished rubber products (not shown) by the cutting mechanism (not shown) of the cutting-and-collecting unit 6. Afterward, the finished rubber products are collected in the hopper 61 of the cutting-and-collecting unit 6 for subsequent use.

Referring back to FIGS. 3, 4 and 6, by virtue of the direct drive motor unit 3, the drive spindle 311 and the output shaft coupling 323 are rotatable together about a co-axial line. Because the cross section of the end 433 of the screw shaft 431 conforms to that of the coupling hole 326 of the output shaft coupling 323, the end 433 of the screw shaft 431 is interlockable with the coupling hole 326 of the output shaft coupling 323 to accomplish assembly of the extruder screw 43 and the output shaft coupling 323 without using additional shaft couplings, thereby reducing occupied space. In this embodiment, after the end 433 of the screw shaft 431 is interlocked into the coupling hole 326 of the output shaft coupling 323, the screw shaft 431 is fixed to the output shaft coupling 323 by a fastener (not shown).

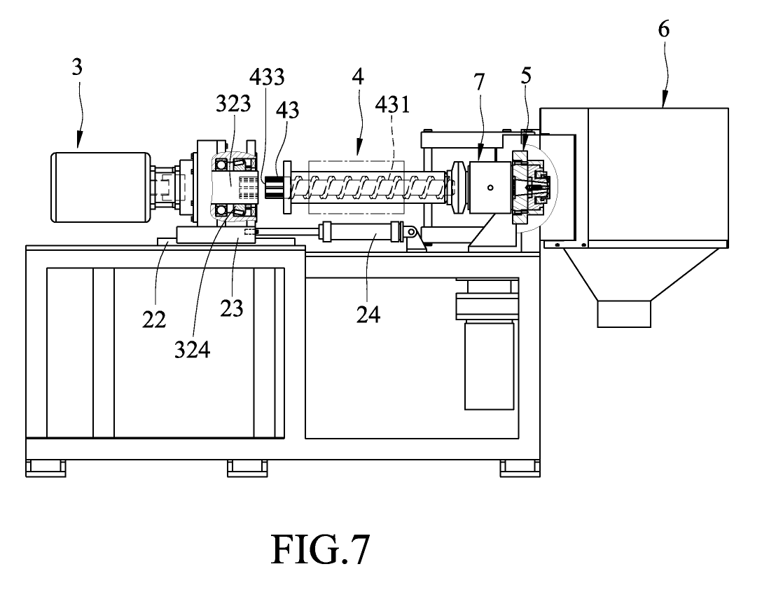

Referring back to FIGS. 3, 6 and 7, when the extruder unit 4 is required to be maintained or repaired, the fastener (not shown) may be first removed to unfix the screw shaft 431 and the output shaft coupling 323. By lengthening the pressure cylinder 24, the sliding seat 23 may be driven to move the direct drive motor unit 3 away from the extruder unit 4, such that the output shaft coupling 323 of the direct drive motor 3 is detached from the extruder screw 43 of the extruder unit 4. Therefore, the extruder unit 4 is ready for maintenance or repair.

Referring back to FIGS. 3, 4 and 6, after maintaining or repairing the extruder unit 4, the pressure cylinder 24 may be shortened to drive the sliding seat 23 and to move the direct drive motor unit 3 back to the extruder unit 4 such that the output shaft coupling 323 of the direct drive motor unit 3 is directly sleeved on the end 433 of the screw shaft 431. After the output shaft coupling 323 and the screw shaft 431 are locked together by the fastener (not shown), the thrust bearing 324 is subjected to an axial load induced by the extruder screw 43 and the output shaft coupling 323 can smoothly rotate.

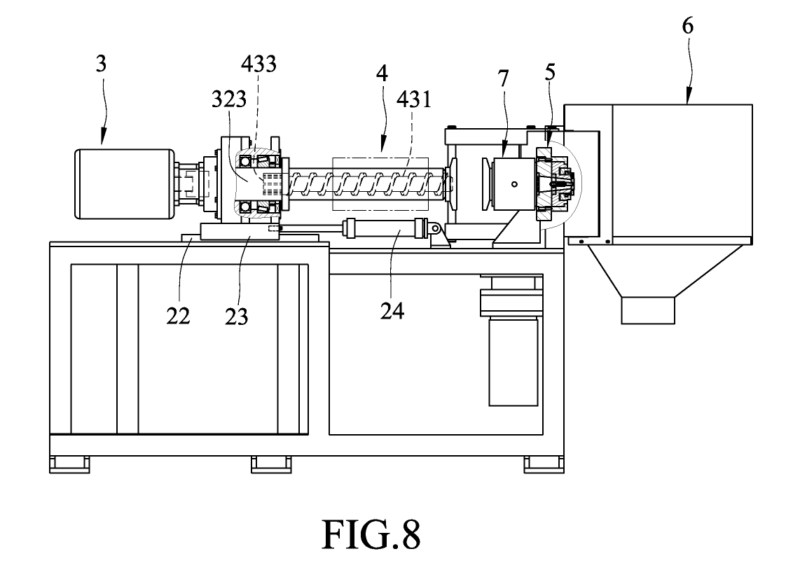

Referring to FIG. 8, in combination with FIGS. 3 and 6, when cleaning of the rubber material is required, the extruder unit 4 and the gear metering pump 7 may be detached from each other. The pressure cylinder is lengthened and drives the sliding seat 23, the direct drive motor unit 3 and the extruder unit 4 to move away from the gear metering pump 7. As such, the rubber material maybe easily removed out without disassembling components.

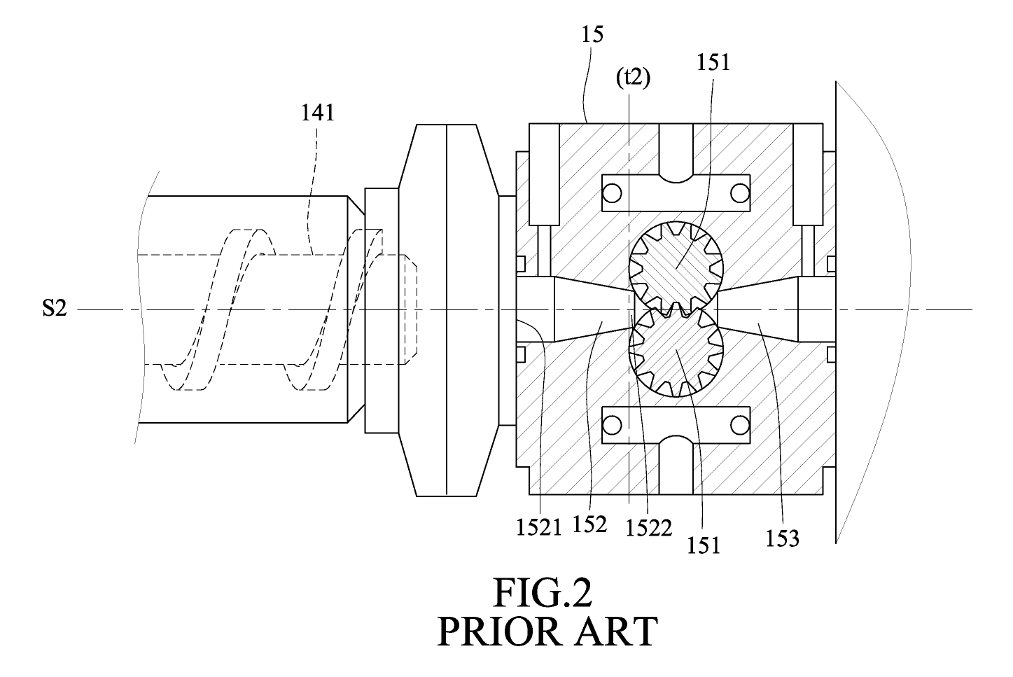

Referring back to FIGS. 4 and 5, because the downstream end 721 of the inlet port 72 of the gear metering pump 7 meets and terminates at the common tangent line (t1) that is tangent to both of the gears 71, the downstream end 721 of the inlet port 72 is farther from a meshing point between the two gears 71, compared to a downstream end 1522 of the inlet port 152 of the prior art shown in FIG. 2, which extends through a common tangent line (t2) of the two gears 151. That is to say, the distance between an upstream end 720 of the inlet port 152 and the meshing point between the two gears 71 is prolonged compared to the upstream end 1521 of the inlet port 152 in the prior art, so that the inlet port 72 is able to provide a sufficient buffering space to buffer high load pressure of the rubber material before the rubber material contacts with the gears 71. When the gears 71 and the rubber material contact each other, generation of instantaneous high pressure is prevented. Therefore, the loading pressure imposed on the gears 71 can be uniform and the quality of the subsequently produced rubber rod (not shown) can be stable.

To sum up, because the output shaft coupling 323 can be aligned axially with the dive spindle 311, and because the screw shaft 431 is directly inserted into the output shaft coupling 323, the direct drive motor unit 3 and the extruder unit 4 can be easily detached from each other, thereby saving the space occupied by the embodiment.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A rubber preforming apparatus, comprising:
a base unit;
a direct drive motor unit slidably disposed on said base unit, and including
a drive motor including a drive spindle, and
a deceleration mechanism including a casing, an input shaft coupling and an output shaft coupling, said input shaft coupling being rotatably disposed in said casing, said drive spindle being inserted into and rotating together with said input shaft coupling, said output shaft coupling being axially aligned and co-rotatably connected to said input shaft coupling, and having a rotation speed smaller than that of said input shaft coupling;
an extruder unit including
an extruder casing disposed adjacent to said output shaft coupling and having a squeezing space for accommodating a rubber material,
a heating member to heat said extruder casing, and
an extruder screw disposed in said squeezing space, and including a screw shaft with one end removably and coaxially inserted into and rotating together with said output shaft coupling for extruding the rubber material; and
a die connected to said extruder casing oppositely of said output shaft coupling for forming the rubber material extruded from said extruder unit into a rubber rod.

2. The rubber preforming apparatus as claimed in claim 1, wherein:
said extruder screw further includes a spiral plate spirally disposed around said screw shaft for delivering the rubber material to said die; and
said output shaft coupling has a coupling hole for said screw shaft to be inserted therein.

3. The rubber preforming apparatus as claimed in claim 2, wherein said coupling hole has a central hole portion and a plurality of angularly spaced apart recesses communicated with and disposed around said central hole portion, each of said recesses being elongated axially, said one end of said screw shaft having a cross section conforming to that of said coupling hole.

4. The rubber preforming apparatus as claimed in claim 2, further comprising a gear metering pump disposed between said squeezing space of said extruder casing and said die, said gear metering pump including an inlet port communicating with said squeezing space, an exit port communicating with said inlet port and said die, and two gears disposed between said inlet and exit ports, said gears being rotatably meshed with each other to squeeze the rubber material from said inlet port to said die through said exit port, said inlet port having a downstream end that meets and terminates at a common tangent line tangent to both of said gears.

5. The rubber preforming apparatus as claimed in claim 2, wherein said deceleration mechanism further includes a thrust bearing disposed between said casing and said output shaft coupling proximally to said screw shaft, and a supporting bearing disposed between said casing and said output shaft coupling at one side of said thrust bearing opposite to said screw shaft.

6. The rubber preforming apparatus as claimed in claim 2, wherein said die includes a die inlet communicating with said squeezing space, a die outlet opposite to said die inlet, and a die cavity connecting between said die inlet and said die outlet.

7. The rubber preforming apparatus as claimed in claim 2, further including a cutting-and-collecting unit disposed on said base unit in proximity to said die for cutting and collecting the rubber rod formed by said die.
